(19) United States
(12) Patent Application Publication
(10) Pub. No.: US 2019/0062052 A1
(43) Pub. Date: Feb. 28, 2019

(54) PRODUCT STORAGE AND AUTOMATION OF TRANSFERRING PRODUCT FROM A REFRIGERATOR CAROUSEL TO COOK STATION

(71) Applicant: Taylor Commercial Foodservice Inc., Rockton, IL (US)

(72) Inventors: Jeffrey L. Sands, Freeport, IL (US); Dennis J. Nelson, Rockford, IL (US)

(73) Assignee: Taylor Commercial Foodservice Inc., Rockton, IL (US)

(21) Appl. No.: 16/107,283

(22) Filed: Aug. 21, 2018

Related U.S. Application Data
(60) Provisional application No. 62/549,495, filed on Aug. 24, 2017.

(51) Int. Cl. B65G 1/10; B65G 1/137; A23L 3/00

(52) U.S. Cl. CPC B65G 1/10; B65G 1/1371; B65G 2203/046; B65G 2201/0202; B65G 2203/0216; A23L 3/001

(57) ABSTRACT

A product storage device is provided. Aspects include a plurality of shelves coupled to a drive system, wherein the plurality of shelves are operable to travel along the drive system to predetermined locations. The product storage unit also includes a transfer conveyer. A lift transfer device is included, wherein the lift transfer device is operable to remove at least one food product from at least one of the plurality of shelves and transfer the at least one food product to the transfer conveyer. And a microcontroller circuit communicatively coupled to a memory is included, wherein the microcontroller circuit is programmable to operate: the drive system, the transfer conveyer, and the lift transfer device.

### RELATED APPLICATION

The present patent document claims the benefit of the filing date under 35 U.S.C. § 119(e) of Provisional U.S. Patent Application Ser. No. 62/549,495, filed Aug. 24, 2017, which is hereby incorporated by reference.

### BACKGROUND

Exemplary embodiments pertain to the art of product storage and more particularly to product storage and automation of transferring product from a refrigerated carousel to cook station.

In restaurant environments, speedy preparation of food can greatly improve customer satisfaction. Traditionally, obtaining the correct ingredients for an ordered food product is performed by human workers that gather the ingredients and prepare the ingredients according to a protocol or recipe. In some restaurants, the gathering and preparation of food products include repeatable steps for much of the food products offered. Traditionally, restaurants offer a limited number of food items per their menu, thus allowing for the inclusion of assembly line type preparation stations. However, these assembly line preparation stations still require human workers to gather and prepare food items.

### BRIEF DESCRIPTION

According to one embodiment, a product storage device is provided. The product storage device includes a plurality of shelves coupled to a drive system, wherein the plurality of shelves are operable to travel along the drive system to predetermined locations. The product storage unit also includes a transfer conveyer. A lift transfer device is included, wherein the lift transfer device is operable to remove at least one food product from at least one of the plurality of shelves and transfer the at least one food product to the transfer conveyer. And a microcontroller circuit communicatively coupled to a memory is included, wherein the microcontroller circuit is programmable to operate: the drive system, the transfer conveyer, and the lift transfer device.

In addition to one or more of the features described above, or as an alternative, further embodiments of the product storage device may include that the plurality of shelves are disposed within an enclosure.

In addition to one or more of the features described above, or as an alternative, further embodiments of the product storage device may include that the enclosure is temperature controlled.

In addition to one or more of the features described above, or as an alternative, further embodiments of the product storage device may include a dispenser arranged over a first portion of the transfer conveyer.

In addition to one or more of the features described above, or as an alternative, further embodiments of the product storage device may include that the first portion of the transfer conveyer is outside the enclosure and a second portion of the transfer conveyer is inside the enclosure.

In addition to one or more of the features described above, or as an alternative, further embodiments of the product storage device may include that the first portion of the transfer conveyer and the second portion of the transfer conveyer are separated by a door.

In addition to one or more of the features described above, or as an alternative, further embodiments of the product storage device may include that the lift transfer device is disposed within the enclosure.

In addition to one or more of the features described above, or as an alternative, further embodiments of the product storage device may include that the plurality of shelves are removeably coupled to the drive system.

In addition to one or more of the features described above, or as an alternative, further embodiments of the product storage device may include one or more cleaning devices, wherein the one or more cleaning devices are disposed within the enclosure and a heating device disposed within the enclosure.

In addition to one or more of the features described above, or as an alternative, further embodiments of the product storage device may include that the microcontroller circuit is further operable to collect inventory data for food products arranged on the plurality of shelves, track an inventory of food products arranged on the plurality of shelves, track a date of entry of the food products on to the plurality of shelves, and store the inventory data in the memory.

In addition to one or more of the features described above, or as an alternative, further embodiments of the product storage device may include a display screen operable to display the inventory of food products and date of entry of the food products.

According to one embodiment, a product storage device is provided. The product storage device includes a plurality of shelves coupled to a drive system, wherein the plurality of shelves are operable to travel along the drive system to predetermined locations, and wherein the plurality of shelves are disposed within an enclosure. The product storage unit also includes a transfer conveyer, and a lift transfer device, wherein the lift transfer device is operable to remove at least one food product from at least one of the plurality of shelves and transfer the at least one food product to the transfer conveyer. The enclosure includes an orifice proximate to the lift transfer device, the orifice allowing access to at least one of the plurality of shelves by the lift transfer device. And the product storage device includes a microcontroller circuit communicatively coupled to a memory, wherein the microcontroller circuit is programmable to operate: the drive system, the transfer conveyer, and the lift transfer device.

In addition to one or more of the features described above, or as an alternative, further embodiments of the product storage device may include that the enclosure is temperature controlled.

In addition to one or more of the features described above, or as an alternative, further embodiments of the product storage device may include that the lift transfer device is disposed external to the enclosure.

In addition to one or more of the features described above, or as an alternative, further embodiments of the product storage device may include that the plurality of shelves are removeably coupled to the drive system.

In addition to one or more of the features described above, or as an alternative, further embodiments of the product storage device may include that the at least one food product is arranged on a tray and the tray is arranged on at least one of the plurality of shelves.

In addition to one or more of the features described above, or as an alternative, further embodiments of the product storage device may include one or more cleaning devices, wherein the one or more cleaning devices are disposed within the enclosure and a heating device disposed within the enclosure.

In addition to one or more of the features described above, or as an alternative, further embodiments of the product storage device may include that the microcontroller circuit is further operable to collect inventory data for food products arranged on the plurality of shelves, track an inventory of food products arranged on the plurality of shelves, track a date of entry of the food products on to the plurality of shelves, and store the inventory data in the memory.

In addition to one or more of the features described above, or as an alternative, further embodiments of the product storage device may include a display screen operable to display the inventory of food products and date of entry of the food products.

According to one embodiment, a product storage device is provided. The product storage device includes a plurality of shelves coupled to a drive system, wherein the plurality of shelves are operable to travel along the drive system to predetermined locations. The product storage unit also includes a transfer conveyer. The product storage unit includes a plurality of trays including food products arranged on each of the plurality of trays, wherein each of the plurality of trays is arranged on one of the plurality of shelves. A lift transfer device is included, wherein the lift transfer device is operable to remove at least one food product from at least one of the plurality of shelves and transfer the at least one food product to the transfer conveyer. A microcontroller circuit communicatively coupled to a memory is included, wherein the microcontroller circuit is programmable to operate: the drive system, the transfer conveyer, and the lift transfer device. And each of the plurality of trays include an identifier, the identifier including tray data that includes food data about one or more food products arranged on each of the plurality of trays, where each of the plurality of trays include an identifier, the identifier including tray data that includes food data about one or more food products arranged on each of the plurality of trays and wherein the identifier comprises at least one of: a barcode, a color code, and an RFID.

### BRIEF DESCRIPTION OF THE DRAWINGS

The following descriptions should not be considered limiting in any way. With reference to the accompanying drawings, like elements are numbered alike:

FIG. 1 is a diagram of a product storage unit according to one or more embodiments;

FIG. 2 is a diagram of a product storage unit according to one or more embodiments; and

FIG. 3 is a diagram of a product storage unit according to one or more embodiments.

### DETAILED DESCRIPTION

There exists a need to be able to store products in a refrigerated cabinet and then automatically dispense them from the refrigerated cabinet to be seasoned and passed along to be cooked at a cooking system. This refrigerated cabinet could be a smart system that tracks inventory levels of the food products stored within and also tracks dates of the entry of the food product into the refrigerated cabinet.

In one or more embodiments, to address the need to store food products and dispense them from a refrigerated environment, a temperature controlled enclosure including a carousel of shelves loaded with trays of various food products is presented. The food products are positioned to an unloading position as orders are placed and the food products are obtained from a selected tray in the carousel and transferred from the selected tray to a designated area for exiting the enclosure by a lift transfer device or are automatically pulled from the enclosure by an arm that moves the food product to a cooking system or a secondary location.

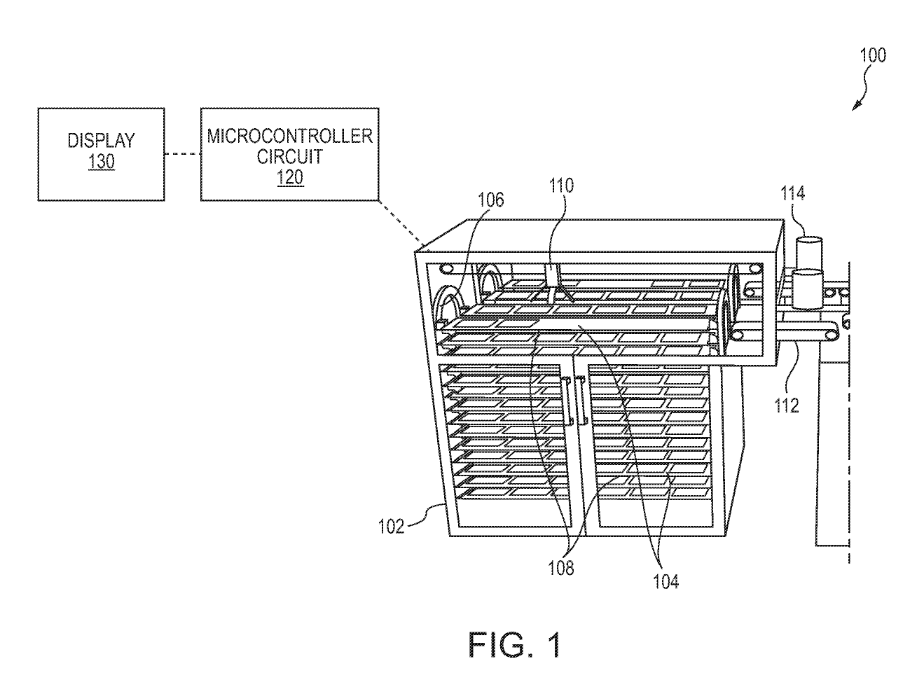

FIG. 1 depicts a product storage unit according to one or more embodiments. The product storage unit 100 includes an enclosure 102 with a carousel of shelves 108 that a plurality of trays 104 are arranged on. The carousel utilizes a drive system 106 that each of the shelves 108 are coupled to allowing for movement of the shelves 108 to different locations within the enclosure 102. Trays 104 containing food products can be arranged on each of the shelves 108 for movement through the carousel by the drive system 106. In one or more embodiments, the drive system 106 can be a belt driver or chain driver. In one or more embodiments, the trays 104 are arranged on the shelves 108 and can include food products arranged on the trays 104. The trays can be a disposable material such as a polystyrene that can be disposed of after the food product is utilized. In another embodiment, the trays can be a reusable tray comprised of a metal, plastic, or any other reusable material which allows for multiple uses of the trays within the product storage unit. The trays can be received pre-packaged from a food product provider or a user of the product storage unit can add the food products to the trays prior to entry into the food product storage unit. In some embodiments, the shelves 108 can have food products arranged directly on the shelves 108 and the shelves 108 can be removable from the drive system 106 for adding food products or for cleaning. In one or more embodiments, the shelves 108 arranged along the drive system 106 are spaced to allow for the entry of the trays 104 containing the food products. Also, the shelves 108 are coupled to the drive system 106 such that the shelving and corresponding trays arranged on the shelves remain in a horizontal position as the food product is rotated around the carousel. In some embodiments, the shelves 108 can utilized a pivot that acts to couple the shelves to the drive system 106 and keep each shelf horizontal at each point along the drive system 106.

The product storage unit 100 also includes a lift transfer device 110, a transfer conveyer 112, and a dispenser 114. The product storage unit 100 includes a microcontroller circuit 120 and a display 130. The microcontroller circuit 120 can operate the drive system 106 to maneuver the shelves 108 and trays 104 to different locations within the enclosure. Also, a manual override can allow for an operator to manually move the trays around the carousel for loading shelves 108 or cleaning the shelves 108, for example. As mentioned above, in some embodiments, the shelves 108 can be removable form the drive system 106 and enclosure 102. The microcontroller circuit 120 can be any type of integrated circuit that is operable to control the mechanical functionality of the product storage unit 100 such as the drive system 106. The microcontroller circuit 120 can be communicatively coupled to the product storage unit 100 and be housed within the product storage unit 100 or separately located from the product storage unit 100. The microcontroller circuit 120 can be communicatively coupled to a memory for storage of data regarding the contents and operations of the product storage unit 100. In addition, the microcontroller circuit 120 can be in electronic communication with the display 130 to display, for example, inventory and tracking data regarding the contents of the food storage unit 100.

In one or more embodiments, the enclosure 102 includes an environmental control system that is utilized to regulate the temperature, humidity, and/or any other environmental conditions inside the enclosure 102. The environmental control system can be any type of environmental system such as, for example, a refrigeration system, a humidity reduction system, a freezer system, a heating system, or any combination of these systems, and the like. The product storage unit 100 can store perishable food products that require specific temperatures within the enclosure to properly store the food products. The food products are arranged on the trays 104 which are loaded on to the shelves 108 in a consistent pattern. For example, a tray may hold six hamburger patties or a tray may hold six fillet of fish patties. While in the illustrated example, six food products are displayed on the each of the trays 104, in the product storage unit 100, any number and/or combination of food products can be arranged on the trays 104. The trays 104 are on the shelves 108 that are coupled to the carousel drive system 106 and the height/location of the trays 104 can be adjusted by maneuvering the shelves 108 along the drive system 106. Each of the trays 104 can have a different type or quantity of food product arranged on the tray 104. When an order comes in for a food product from a point of sale system, the carousel drive system 106, utilizing a motor or other means, can position a shelf 108 carrying a tray 104 containing the desired food product to the top of the enclosure 102. The lift transfer device 110 can obtain the desired food product and transfer it to the transfer conveyer 112. The transfer conveyer 112 has a first portion within the enclosure 102 and a second portion outside the enclosure 102. The first portion and the second portion of the transfer conveyer 112 can be separated by a door or a flap or any other means to allow for transfer of the food product outside the enclosure 102 and minimizing any loss of temperature controller within the enclosure 102. The dispenser 114 is arranged over the second portion of the transfer conveyer 112 outside the enclosure 102 to dispense ingredients on to the food product such as. In one or more embodiments, the transfer conveyer 112 can be two conveyers with one conveyer inside the enclosure 102 and another conveyer outside the enclosure 102. The two conveyers can transfer a food product from inside the enclosure 102 to the outside conveyer which has the dispenser 114 arranged over the outside conveyer.

While in the illustrated example, the lift transfer 110 is shown as a mechanical claw, it can be understood that any type of device operable to obtain a food product from the tray 104 and transfer the food product to the transfer conveyer 112 can be utilized for this product storage unit 100. The lift transfer device 110 is disposed within the enclosure 102 and is operable to obtain a specific food item from a tray 104. The lift transfer device 110 is operated by the microcontroller 120 which, based at least in part on a food order, identifies the proper food product and sends instructions for the lift transfer device 110 to obtain and transfer the food product. The microcontroller 120 receives inventory data about the food products that are stored within the product storage unit 100 and tracks the entry and exit of each food product. For example, if four trays 104 are loaded on to four different shelves 108 that are coupled to the carousel drive system 106, the microcontroller will track the type and quantity of food products on each tray 104 along with the date and/or time of entry of the tray into the product storage unit 100 and store this data in a memory. The microcontroller 120 can manage the inventory utilizing various queuing techniques such as, for example, a first-in, first-out (FIFO) system. When an order for a food product is received, the microcontroller 120 can identify one or more food products that are present in the inventory of the food storage unit 100 that meet the requirements of the order. For example, if an order for a 4 oz. beef patty is received, the microcontroller 120 can identify one or more trays 104 that contain the type and size beef patty. When employing a FIFO system, the microcontroller 120 can also utilize the data regarding the date of entry of the beef patties on the identified one or more trays and select a tray that has the oldest food product for selection and transfer to the transfer conveyer 112 to complete the order. By selecting the oldest item meeting the requirements, the food storage unit 100 can avoid unnecessary spoilage of food as most food products have a limited amount of time they can be stored before having to be disposed. In addition to the FIFO system for inventory controller described above, the microcontroller 120 can utilize other inventory controls to dispense the food product. For example, if three trays include a requested food product and each of the three trays have the same food product age (i.e., the trays were loaded at the same time), the microcontroller may select the food product from a tray containing the least number of food products to facilitate the freeing up of shelf space for input of a new tray on to a shelf 108. In this example, removing food product from a tray containing only the one remaining food product allows for the tray to be removed because it is empty and allow for the loading of new tray having more product. Various optimization techniques can be utilized to facilitate the adding and removing of food product within the product storage unit 100. In some cases, the optimization techniques for maintaining a more robust and diverse inventory can override the FIFO system.

The food storage unit 100 is able to receive individual trays 104 that can be loaded and unloaded from the shelves 108. As the trays 104 are loaded, techniques can be utilized to inform the food storage unit 100 of the quantity, type, and any other information about the food product contained on the loaded tray. Some examples include a radio frequency identification (RFID) that is read to update the microcontroller 120 about the food product. Other techniques include the entry of a code on a keypad entered by a user as the user loads the trays in to specific shelf 108 within the product storage unit 100. Some other techniques include the use of a color coded system for inputting the trays, using notches on the trays, and a label system for inputting the trays. Sensors arranged within the enclosure can be utilized to collect information about the trays 104 with the food products. As the trays are loaded, a time stamp can be recorded and stored in to memory to track the age of the food product as it is dispensed within the food product storage 100. In addition, visual and weight sensors can be utilized to identify the type and quantity of food products being loaded into the product storage unit 100. A visual sensor can determine based on visual processing techniques the type of food product on a tray. A weight sensor may have the weight of certain types of food products preloaded into a memory for determining the type and quantity of certain food products. Some other types of sensors include but are not limited to visual sensors, bar code readers, RFID sensors, and the like.

In one or more embodiments, the display 130 for the product storage unit 100 can be utilized to notify a user of certain conditions within the product storage unit 100. For example, the microcontroller 120 could determine that a food product has reached or is close to reaching its expiration date and could generate an alert or a notification to be shown on the display 130. Inventory levels could be shown in real time on the display 130 snap shot of the system and also deliver information about potential issues that may arise. Ordering trends, for example, may be displayed to show a need to replenish inventory for certain food products.

In one or more embodiments, the product storage unit 100 is of a modular design allowing for interchangeability of the unit within a larger system. In addition, one or more of the product storage units 100 can be arranged and positioned adjacent to each other to facilitate space savings while not losing functionality within a larger system or systems. The trays 104, lift transfer device 110, transfer conveyance 112, and dispenser 114 can be removed or interchanged with similar parts for similar operation.

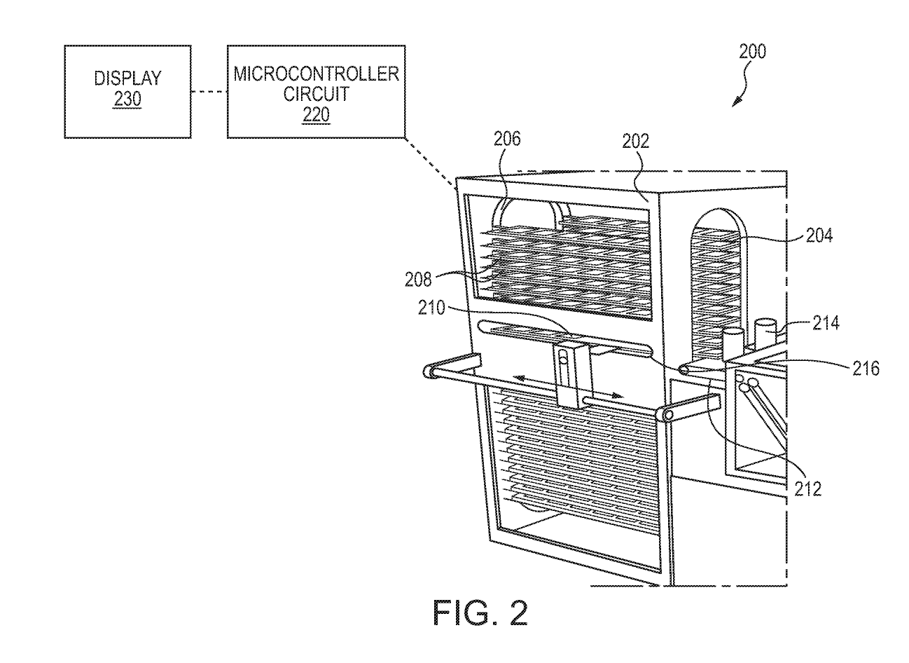

FIG. 2 depicts another embodiment of a product storage unit. The product storage unit 200 includes an enclosure 202 with a carousel of shelves 208 that have trays 204 arranged on top of the shelves 208. The carousel utilizes a drive system 206 that each of the shelves 208 are coupled to allowing for movement of the trays 204 arranged on the shelves 208 along the drive system 206 to different locations within the enclosure 202. A lift transfer device 210 is coupled to the enclosure 202 and can move laterally along the width of the enclosure 202. The enclosure 202 includes an orifice 216 that allows access to one or more trays 204 for the lift transfer device 210 to obtain food products arranged on the trays 204. The lift transfer device 210 can be arranged to move on a track or rail in a horizontal fashion along the trays 204 allowing for access by the lift transfer device 210. The lift transfer device 210 can obtain a food product from a tray 204 and transfer this food product to a transfer conveyance 212. A dispenser 214 can be arranged over all or a portion of the transfer conveyance 210 to dispense ingredients such as seasoning.

The product storage unit 200 includes a microcontroller circuit 220 and a display 230. The microcontroller circuit 220 can be any type of integrated circuit that is operable to control the mechanical functionality of the product storage unit 200. The microcontroller circuit 220 can be communicatively coupled to the product storage unit 200 and be housed within the product storage unit 200 or separately located from the product storage unit 200. The microcontroller circuit 220 can be communicatively coupled to a memory for storage of data regarding the contents and operations of the product storage unit 200. In addition, the microcontroller circuit 220 can be in electronic communication with the display 230 to display, for example, inventory and tracking data regarding the contents of the food storage unit 200.

In one or more embodiments, the enclosure 202 includes an environmental control system that is utilized to regulate the temperature, humidity, and/or any other environmental conditions inside the enclosure 202. The environmental control system can be any type of environmental system such as, for example, a refrigeration system, a humidity reduction system, a freezer system, a heating system, or any combination of these systems, and the like. The shelves 208 are coupled to the carousel drive system 206 and the height/location of the shelves 208 can be adjusted by travelling along the drive system 206. The drive system 206 maneuvers the shelves 208 to various positions within the enclosure 202 in a substantially 360 degree arrangement. Each of the trays 204 arranged on the shelves 208 can have a different type or quantity of food product on the tray 204. When an order comes in for a food product from a point of sale system, the carousel drive system, utilizing a motor or other means, can position a tray 204 arranged on a shelf 208 containing the desired food product to a location adjacent to the orifice 216 allowing access to by lift transfer device 210. In some embodiments, the orifice 216 can include a mechanical or electronically operated door or flap that opens only when the lift transfer device 210 is obtaining a food product. The door would allow for the environmental system to maintain environmental conditions within the enclosure 202.

In one or more embodiments, the product storage unit 200 can utilize inventory tracking and quality assurance techniques outlined above. Additionally, the shelves 204 can be removeably coupled to the carousel drive system 206 and the inventory can be tracked utilizing techniques such as RFID, user data entry, visual and weight sensors, and the like that obtain data about the food products arranged on the trays 204 when the trays are loaded on to the shelves 208 in the product storage unit 200.

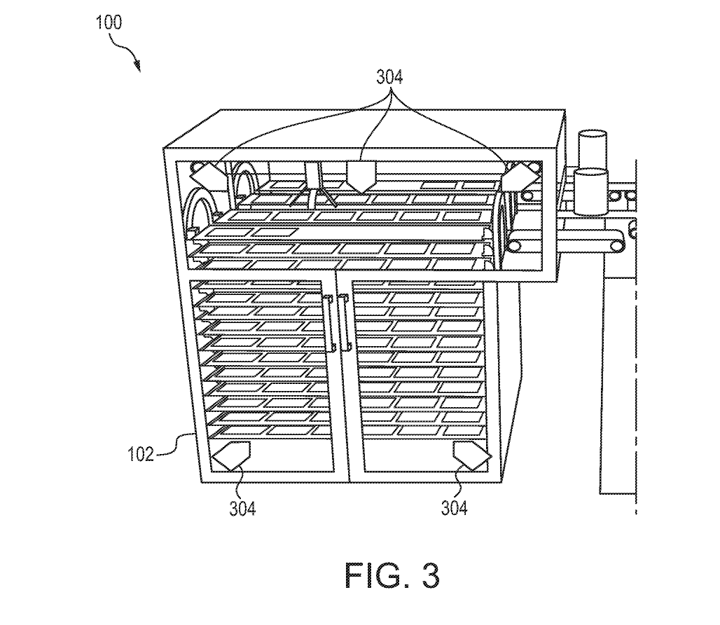

FIG. 3 depicts a product storage unit with auto cleaning according to one or more embodiments. The product storage unit 100 includes the enclosure 102 along with the components of depicted FIG. 1. The product storage unit 100 also includes cleaning devices 304 disposed within the enclosure 102. The cleaning devices 304 can include, for example, high pressure cleaning nozzles and/or rotary jets that can spray water or other cleaning agents over any and all surfaces within the product storage device. The enclosure 102 can be sealed to reduce water or other cleaning agents from leaking from the enclosure. A heating system can be utilized for any steam cleaning of the product storage unit 100. A drain or hose can be attached to the product storage unit to remove any excess water and/or cleaning agents from the enclosure 102 and the heating system can evaporate the excess water and/or cleaning agents. The product storage unit 100 can have the enclosure closed and set to auto clean mode when the product storage unit 100 is not in service such as at night time. The cleaning devices 304 could spray down the shelves, enclosure, and the lift transfer device with high pressured nozzles and then sanitize so that the product storage unit 100 could be utilized the following morning.

In another embodiment, while the cleaning devices 304 are in operation, the carousel drive system (106 from FIG. 1) can rotate the shelves (108 from FIG. 1) along the drive system 106 to allow for each shelf to be cleaned.

Some technical benefits of the product storage unit include product delivery to a cooking system is automatically pulled from the refrigerated enclosure as it is needed and does not require an operator to manually perform this task. The benefits will be in reduced labor costs, food safety, better food quality, better managed inventory, less food contamination.

A detailed description of one or more embodiments of the disclosed apparatus and method are presented herein by way of exemplification and not limitation with reference to the Figures.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A product storage device comprising:
a plurality of shelves coupled to a drive system, wherein the plurality of shelves are operable to travel along the drive system to predetermined locations;
a transfer conveyer;
a lift transfer device, wherein the lift transfer device is operable to remove at least one food product from at least one of the plurality of shelves and transfer the at least one food product to the transfer conveyer; and
a microcontroller circuit communicatively coupled to a memory, wherein the microcontroller circuit is programmable to operate: the drive system, the transfer conveyer and the lift transfer device.

2. The product storage device of claim 1, wherein the plurality of shelves are disposed within an enclosure.

3. The product storage device of claim 2, wherein the enclosure is temperature controlled.

4. The product storage device of claim 2 further comprising a dispenser arranged over a first portion of the transfer conveyer.

5. The product storage device of claim 4, wherein the first portion of the transfer conveyer is outside the enclosure; and
wherein a second portion of the transfer conveyer is inside the enclosure.

6. The product storage device of claim 5, wherein the first portion of the transfer conveyer and the second portion of the transfer conveyer are separated by a door.

7. The product storage device of claim 2, wherein the lift transfer device is disposed within the enclosure.

8. The product storage device of claim 1, wherein the plurality of shelves are removeably coupled to the drive system.

9. The product storage device of claim 2 further comprising:
one or more cleaning devices, wherein the one or more cleaning devices are disposed within the enclosure; and
a heating device disposed within the enclosure.

10. The product storage device of claim 1, wherein the microcontroller circuit is further operable to:
collect inventory data for food products arranged on the plurality of shelves;
track an inventory of food products arranged on the plurality of shelves;
track a date of entry of the food products on to the plurality of shelves; and
store the inventory data in the memory.

11. The product storage device of claim 10 further comprising:
a display screen operable to display the inventory of food products and date of entry of the food products.

12. A product storage unit comprising:
a plurality of shelves coupled to a drive system, wherein the plurality of shelves are operable to travel along the drive system to predetermined locations, and wherein the shelves are disposed within an enclosure;
a transfer conveyer;
a lift transfer device, wherein the lift transfer device is operable to remove at least one food product from at least one of the plurality of shelves and transfer the at least one food product to the transfer conveyer;
wherein the enclosure includes an orifice proximate to the lift transfer device, the orifice allowing access to at least one of the plurality of shelves by the lift transfer device; and
a microcontroller circuit communicatively coupled to a memory, wherein the microcontroller circuit is programmable to operate: the drive system, the transfer conveyer and the lift transfer device.

13. The product storage device of claim 12, wherein the enclosure is temperature controlled.

14. The product storage device of claim 12, wherein the lift transfer device is disposed external to the enclosure.

15. The product storage device of claim 12, wherein the plurality of shelves are removeably coupled to the drive system.

16. The product storage device of claim 12, where the at least one food product is arranged on a tray; and
where the tray is arranged on at least one of the shelves.

17. The product storage device of claim 12 further comprising:
one or more cleaning devices, wherein the one or more cleaning devices are disposed within the enclosure; and
a heating device disposed within the enclosure.

18. The product storage device of claim 12, wherein the microcontroller circuit is further operable to:
collect inventory data for food products arranged on the plurality of shelves;
track a removal of each of the food products arranged on the plurality of shelves;
track a date of entry of the food products on to the plurality of shelves; and store the inventory data and the date of entry in the memory.

19. The product storage device of claim 18 further comprising:
a display screen operable to display the inventory data of food products and date of entry of the food products.

20. A product storage device comprising:
a plurality of shelves coupled to a drive system, wherein the plurality of shelves are operable to travel along the drive system to predetermined locations;
a transfer conveyer;
a plurality of trays including food products arranged on each of the plurality of trays, wherein each of the plurality of trays is arranged on one of the plurality of shelves;
a lift transfer device, wherein the lift transfer device is operable to remove at least one food product from at least one of the plurality of trays and transfer the at least one food product to the transfer conveyer;
a microcontroller circuit communicatively coupled to a memory, wherein the microcontroller circuit is programmable to operate: the drive system, the transfer conveyer, and the lift transfer device;
wherein each of the plurality of trays include an identifier, the identifier including tray data that includes food data about one or more food products arranged on each of the plurality of trays; and
wherein the identifier comprises at least one
of: a barcode, a color code, and an
RFID.
